(19) United States
(12) Patent Application Publication
(10) Pub. No.: US 2020/0285674 A1
(43) Pub. Date: Sep. 10, 2020

(54) METHOD AND APPARATUS FOR PROVIDING CUSTOMIZED IDENTIFICATION CARD

(71) Applicant: Sang Hyun SHIN, Seoul (KR)

(72) Inventor: Sang Hyun SHIN, Seoul (KR)

(21) Appl. No.: 16/812,222

(22) Filed: Mar. 6, 2020

(30) Foreign Application Priority Data
Mar. 8, 2019 (KR) 10-2019-0027125
Mar. 8, 2019 (KR) 10-2019-0027126
Oct. 1, 2019 (KR) 10-2019-0121714
Jan. 9, 2020 (KR) 10-2020-0002917

(51) Int. Cl. G06F 16/93; G06F 3/0484; G06F 16/9535

(52) U.S. Cl. CPC G06F 16/93; G06F 16/9535; G06F 3/04842; G06F 3/04845

(57) ABSTRACT

Provided is a method for providing a customized identification (ID) card performed by a computing device. The method comprises displaying a profile of a user, and displaying an ID card of the user in response to selecting the profile of the user, wherein the ID card comprises one or more functional elements, and a layout of the ID card is customized according to an input of the user.

### CROSS-REFERENCE TO RELATED APPLICATIONS

This application claims the benefit of Korean Patent Application No. 10-2019-0027125, filed on Mar. 8, 2019, Korean Patent Application No. 10-2019-0027126, filed on Mar. 8, 2019, Korean Patent Application No. 10-2019-0121714, filed on Oct. 1, 2019, and Korean Patent Application No. 10-2020-0002917, filed on Jan. 9, 2020, in the Korean Intellectual Property Office, the disclosure of which is incorporated herein by reference in its entirety.

### BACKGROUND

### 1. Field

The present disclosure relates to a method of providing an identification (ID) card, and more particularly, to a method and apparatus for providing an ID card that can be freely customized by a user.

### 2. Description of the Related Art

With the development of smart devices, it is becoming common to store a lot of information used in daily life in mobile devices such as smartphones and view the information when necessary. In particular, there are applications such as address book and business card applications that gather and provide profiles and information of people. Such an application enables a person to easily find a phone number or an e-mail address that is hard to remember but provides only fragmentary information in a uniform format.

Today is called the era of self-promotion (PR). People want to reveal their own personalities that differentiate them from others and share their lives with acquaintances through social network service (SNS) or personal homepages. If there is a solution that enables people to express their desire for self-PR more easily and simply, it will have a positive effect on people's community formation and self-achievement.

### SUMMARY

An embodiment of the present disclosure provide a method and apparatus for freely customizing a user's identification card and information shown to others according to the user's personality.

Another embodiment of the present disclosure also provide a method and apparatus for easily updating changed information of a user to the other party.

Still another embodiment of the present disclosure also provide a method and apparatus for allowing a user to share his or her creation or useful information with the other party and receive a reward for that.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an embodiment of the present disclosure, a method for providing a customized identification (ID) card is performed by a computing device, the method comprises displaying a profile of a user, and displaying an ID card of the user in response to selecting the profile of the user, wherein the ID card comprises one or more functional elements, and a layout of the ID card is customized according to an input of the user.

According to another embodiment of the present disclosure, a method for providing a customized ID card is performed by a computing device, the method comprises querying a list of functional elements provided by a server, selecting functional elements to be applied to the ID card from the queried functional element list, and customizing a layout of the ID card by placing or setting the selected functional elements on the layout, wherein the ID card is provided in response to selecting a profile associated with the ID card.

According to an embodiment of the present disclosure, an apparatus for providing a customized ID card, the apparatus comprises a processor, a memory which loads a computer program to be executed by the processor, and a storage which stores the computer program, wherein the computer program comprises instructions for performing an operation of displaying a profile of a user and an operation of displaying an ID card of the user in response to selecting the profile of the user, wherein the ID card comprises one or more functional elements, and a layout of the ID card is customized according to an input of the user.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the configuration of a system including an apparatus for providing a customized identification (ID) card according to embodiments of the present disclosure;

FIG. 2 is a flowchart illustrating a method of providing a customized ID card according to embodiments of the present disclosure;

FIGS. 3 through 5 are conceptual diagrams for further explaining the method described in FIG. 2;

FIGS. 6A to 6C are conceptual diagrams for explaining various application embodiments in the method described in FIG. 2;

FIG. 7 is a flowchart illustrating a method of customizing a layout and a method by which another user queries the layout according to embodiments of the present disclosure;

FIG. 8 is a flowchart illustrating a method of customizing a layout according to embodiments of the present disclosure;

FIG. 9 is a flowchart illustrating a method of executing a page edit mode of operation S2100 of FIG. 8;

FIGS. 10 and 11 are conceptual diagrams for further explaining the method described in FIG. 9;

FIGS. 12 to 13B are conceptual diagrams for more specifically explaining functions and a user interface (UI)/user experience (UX) of a controller described in FIG. 11;

FIG. 14 is a conceptual diagram for explaining a method of registering and downloading a controller through a market according to embodiments of the present disclosure;

FIG. 15 is a flowchart illustrating a method of querying a list of registered functional elements in operation S2200 of FIG. 8;

FIG. 16 is a conceptual diagram for further explaining the method described in FIG. 15;

FIG. 17 is a flowchart illustrating a method of selecting a functional element type in operation S2220 of FIG. 15;

FIGS. 18 and 19 are conceptual diagrams for further explaining the method described in FIG. 17;

FIG. 20 is a flowchart illustrating a method of storing a customized layout in operation S2400 of FIG. 8;

FIGS. 21 through 23 are conceptual diagrams for further explaining the method described in FIG. 20;

FIG. 24 is a flowchart illustrating a specific embodiment of operation S2410 of FIG. 20;

FIG. 25 is a flowchart illustrating a method of loading a stored layout in operation S2413 of FIG. 24;

FIG. 26 is a flowchart illustrating a method of clipping and storing a layout of another user according to embodiments of the present disclosure;

FIGS. 27 through 29 are conceptual diagrams for further explaining the method described in FIG. 26;

FIGS. 30A to 31 are conceptual diagrams for explaining a method of customizing a color scheme of an ID card according to embodiments of the present disclosure; and

FIG. 32 illustrates the hardware configuration of an example computing device that can implement apparatuses according to various embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present invention will be described in detail with reference to the accompanying drawings.

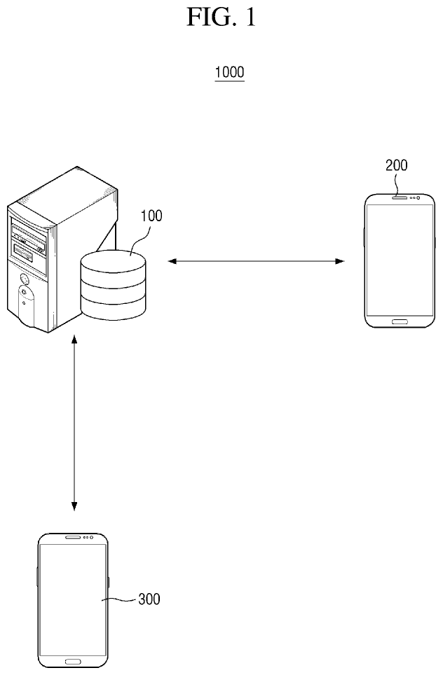

FIG. 1 illustrates the configuration of a system 1000 including an apparatus for providing a customized identification (ID) card according to embodiments of the present disclosure.

Referring to FIG. 1, the system 1000 including the apparatus for providing a customized ID card according to the embodiments may include a server 100, a first user terminal 200, and a second user terminal 300. Depending on situation, the apparatus for providing a customized ID card may be the server 100, the first user terminal 200, or the second user terminal 300 of FIG. 1. However, this is merely an exemplary embodiment for achieving the objectives of the present disclosure, and some components can be added or removed as needed. Each component will be briefly described below.

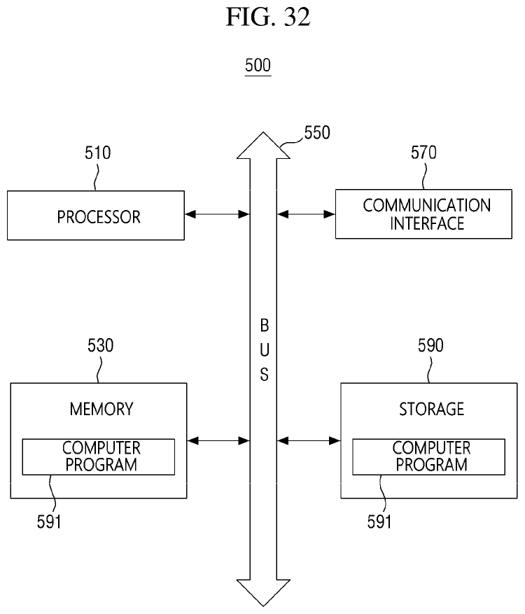

The server 100 is a computing device or system that provides a first user with a means by which the first user can customize his or her ID card and provides the customized ID card of the first user to a second user. The server 100 may consist of one or more server devices (i.e., computing devices). Here, the computing device may be a notebook computer, a desktop computer, or a laptop computer. However, the computing device is not limited to the above examples and may be any type of device having a computing function and a communication function. Some examples of the computing device will be described in more detail later with reference to FIG. 32.

The first user terminal 200 is a computing device used by the first user who desires to customize an ID card according to his or her taste or purpose and display the customized ID to the second user. The first user terminal 200 may be a smartphone or a smart watch. However, the first user terminal 200 is not limited to the above examples and may be any type of device having a computing unit and a communication unit.

The second user terminal 300 is a computing device used by the second user who desires to view information such as contact information or a profile of the first user. Like the first user terminal 200, the second user terminal 300 may be a smartphone or a smart watch. However, the second user terminal 300 is not limited to the above examples and may be any type of device having a computing unit and a communication unit.

In the system 1000 of FIG. 1, the first user terminal 200 edits and customizes the ID card of the first user by communicating with the server 100 and registers the customization result with the server 100. The second user terminal 300 queries the customized ID card of the first user through the server 100 or updates the first user's contact information, profile or other information stored in the second user terminal 300 through the server 100.

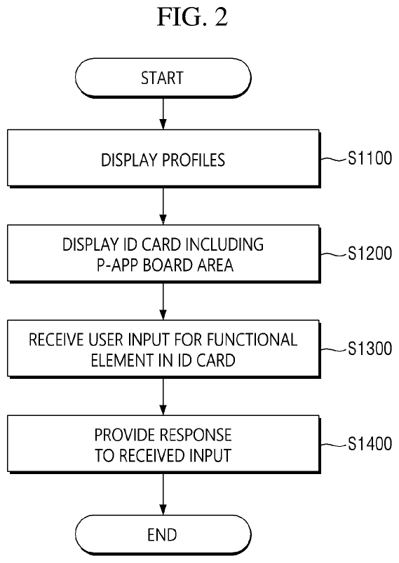

In some embodiments, an application may be downloaded to each of the first user terminal 200 and the second user terminal 300, and the ID card of the first user may be customized, or the customized ID card may be queried through the application. The application refers to an application program that can be executed on a smart device such as a smartphone or a smart TV. Further description will be given below with reference to FIG. 2.

Each operation of a method of providing a customized ID card to be described in FIG. 2 may be implemented as one or more instructions to be executed by a processor of a computing device.

An instruction, as used herein, is a series of computer-readable commands grouped together based on function, is a component of a computer program, and is executed by a processor.

All operations included in the method of providing a customized ID card may be executed by one physical computing device. Alternatively, first operations of the method may be performed by a first computing device, and second operations of the method may be performed by a second computing device. That is, the method may be performed by a plurality of computing devices.

The method of providing a customized ID card may be performed in various systems and/or environments. For ease of understanding, the following description will be given based on the environment exemplified in FIG. 1. In addition, the execution order of operations included in methods to be described below can be changed as needed as long as it is logically feasible.

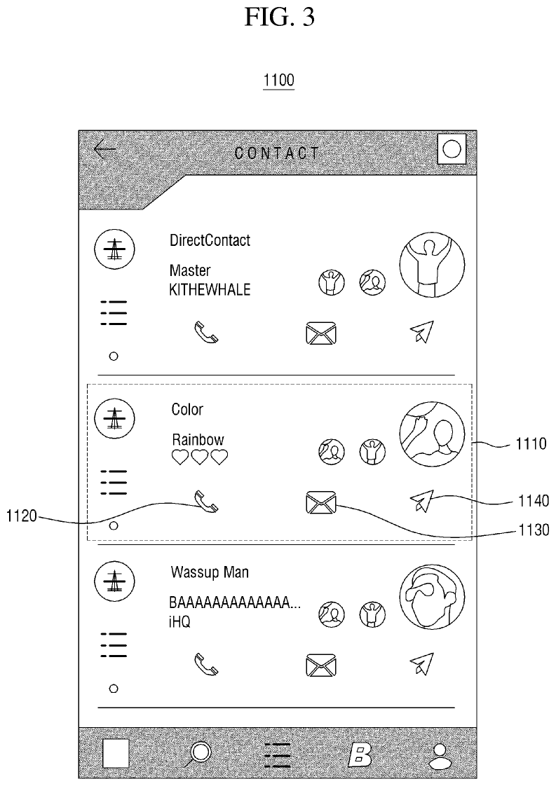

FIG. 2 is a flowchart illustrating a method of providing a customized ID card according to embodiments of the present disclosure. FIGS. 3 through 5 are conceptual diagrams for further explaining the method described in FIG. 2. The customized ID card providing method of FIG. 2 includes four operations S1100 through S1400. FIGS. 3 through 5 respectively illustrate example screens more intuitively showing operations S1100, S1200 and S1300 of FIG. 2.

In operation S1100, a terminal of a user displays profiles of other users. Here, the user may be the second user described in FIG. 1, and the terminal displaying ID cards of other users may be the second user terminal 300. Referring to FIG. 3, a screen 1100 displaying profiles of other users is illustrated. Profiles of a plurality of other users are displayed in parallel on the screen 1100, and a profile 1110 of the first user of FIG. 1 is included in the profiles. In an embodiment, the screen 1100 may be a screen displaying profiles of acquaintances of the user, people followed by the user, or people whose contact information is stored in an address book of the user and may be a screen of an address book or business card application.

The profile 1110 may include various personal information or function buttons. For example, the profile 1110 may include a phone number or a phone number button 1120 for calling the first user, e-mail address information or an e-mail button 1140 for sending an e-mail to the first user, and/or a message sending button 1130 for sensing a message to the first user.

In an embodiment, each button or information of the profile 1110 may be displayed to the second user after being customized by the first user. For example, if the first user does not want to disclose his or her e-mail address information, the first user may customize his or her profile 1110 such that the e-mail button 1140 is not shown in the profile 1110 on the screen 1100. Alternatively, if the first user wants his or her picture to be displayed larger, the first user may customize his or her profile 1110 by increasing an area in which the picture is displayed and reducing an area in which other information is displayed. The profile 1110 customized by the first user as described above is registered with the server 100. Later, when the second user queries the profile 1110 of the first user, the profile 1110 customized by the first user is displayed.

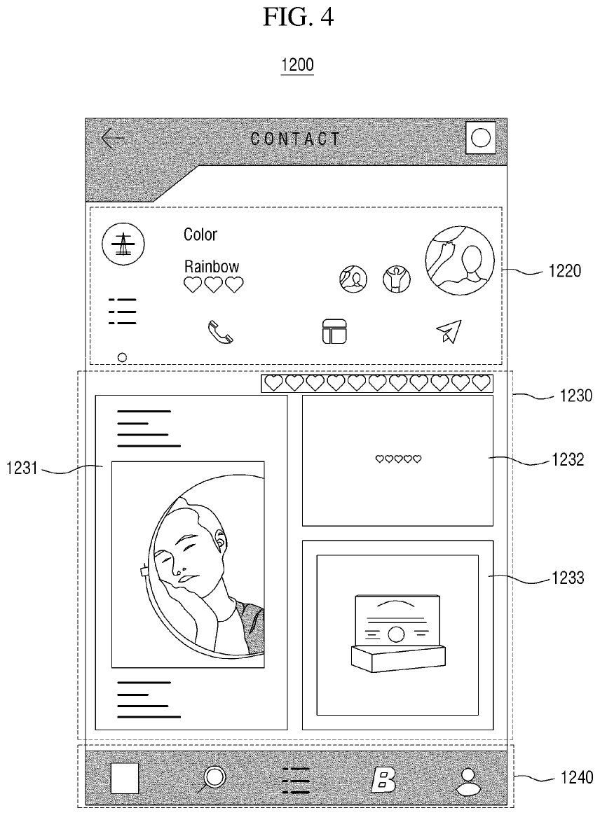

In operation S1200, when the second user views the displayed profile 1110 and selects the profile 1110 of the first user, the first user's ID card including a P-app board area is displayed. Referring to FIG. 4, an example of an ID card 1200 including a P-app board area is illustrated. The P-app is a user interface tool that manipulates an application program running on a computing device and displays the manipulation result. For example, the P-app may be a functional element that performs the same function as a widget or a gadget.

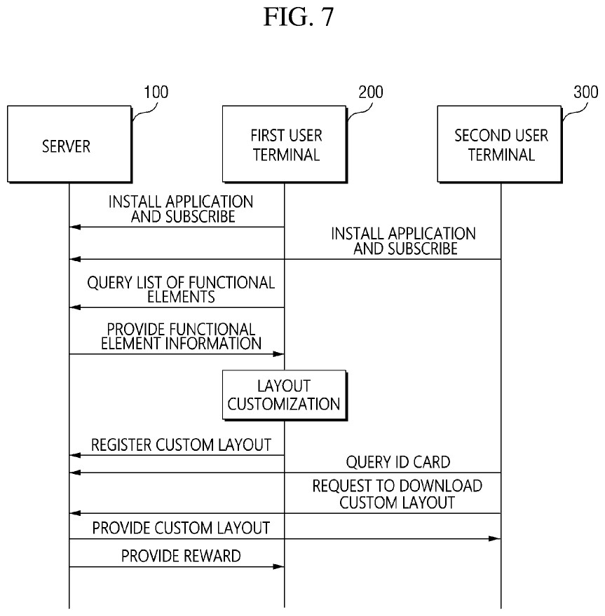

The first user may customize the content and layout of the ID card 1200 according to his or her taste and purpose. In the example of FIG. 4, the ID card 1200 includes an information area 1220 and a P-app board area 1230, but the present disclosure is not limited thereto. The first user registers the ID card 1200 with the server 100 by freely placing the content and the layout using functional elements or a controller provided by the server 100 and uploading the result. A specific method by which the first user customizes and registers the ID card 1200 will be described in detail later with reference to FIG. 7 and subsequent drawings.

Various functional elements and content may be placed in the ID card 1200 according to the taste or purpose of the first user. For example, various functional elements such as a blog-like P-app 1231 decorated by freely placing text, images or videos, a sticker 1232 displaying the current feeling as a figure, and a P-app 1233 displaying information about a recommending product may be placed. Each of the placed functional elements 1231, 1232 and 1233 may be, for example, a P-app, an application program, or an application configured to provide a specific function or information.

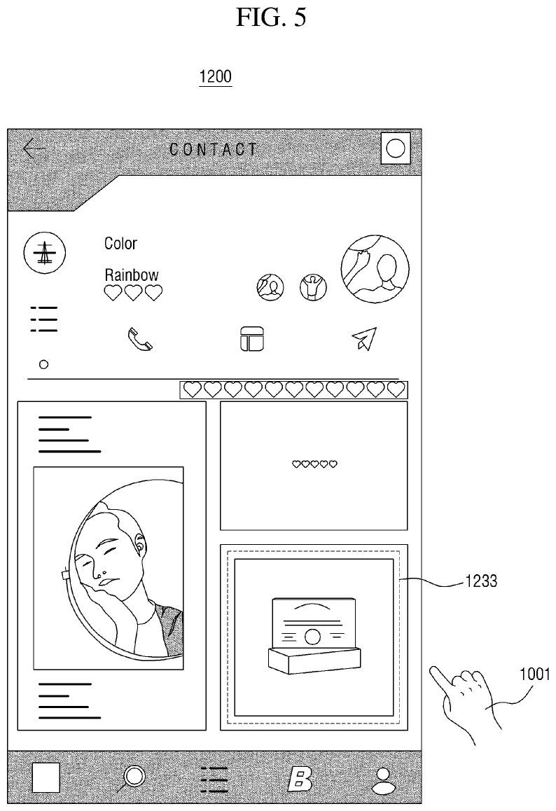

In operation S1300, the second user may apply a user input to obtain addition information or a response for a specific functional element in the displayed ID card 1200. For example, when the second user wants to know additional information about the product functional element 1233 (e.g., a functional element such as a P-app that introduces soap products) in the ID card 1200, the second user may apply a touch input 1001 to the product functional element 1233 through the second user terminal 300 as illustrated in FIG. 5. The second user terminal 300 receives the touch input 1001 and processes an instruction related to the touch input 1001.

In operation S1400, the second user terminal 300 provides a response to the received touch input 1001 to the second user. Here, the provided response is a response preset by the first user to be displayed when a touch input is applied to the product functional element 1233. The provided response may be, but is not limited to, a response that displays information about a product (e.g., soap) introduced in the product functional element 1233, such as the size, material and fragrance of the product, or information about the sale of the product such as a seller of the product, contact information of the seller and a link to a shopping mall selling the product. For example, if the functional element 1233 is a photo P-app, not a product functional element, pressing the functional element 1233 may execute a response for showing a large photo. Alternatively, if the functional element 1233 is a video P-app, pressing the functional element 1233 may execute a response for playing back a video. Alternatively, if the functional element 1233 is a music P-app, pressing the functional element 1233 may execute a response for playing music.

Although not illustrated in the embodiment of FIGS. 3 through 5, the ID card 1200 may also include a map P-app for providing information about a good restaurant as a functional element. In this case, when the second user touches the map P-app, the second user terminal 300 may provide information about a good restaurant as a response, together with a map showing the location of the restaurant.

In an embodiment, the second user terminal 300 may receive a secondary input for the provided response and provide a secondary response to the secondary input. For example, when the second user applies a secondary touch input to a map provided as a response in the example of the map P-app above, the second user terminal 300 may provide a secondary response for executing a navigation system that guides a route to a good restaurant.

In an embodiment, when the second user purchases a product or a service through a functional element provided in the ID card 1200, the first user may be provided with a reward for the purchase. For example, as in the embodiment of operation S1400, when the second user is guided about a soap product or a restaurant by touching a functional element of the ID card 1200 and actually purchases the product or eats at the restaurant, this history may be collected in the server 100, and a corresponding reward may be provided to the first user.

Until now, the method and apparatus for providing a customized ID card according to the embodiments of the present disclosure have been described with reference to FIGS. 1 through 5.

Through the above configurations, a first user can freely customize his or her ID card and information according to his or her taste and purpose and provide the customized ID card and information to a second user, and the second user can use the ID card reflecting the personality of the first user instead of following the uniform format of a conventional address book or business card application. In addition, the second user can access various content and information through a P-app board area of the ID card.

Moreover, the first user can update his or her ID card and information at any time and register the update with a server, and the registered update is automatically reflected in a second user terminal when the second user accesses the server. Therefore, there is no need for the first user to individually contact the second user to deliver the update to the second user.

In addition, the first user can freely customize the size and shape of the P-app board area decorating the ID card. Thus, various functional elements (e.g., P-apps such as product introduction, map, photo, graphics interchange format (GIF), video, YouTube, sound cloud, music, map, blog, guestbook, timeline view, folder link bar, folder preview box, folder slide show, folder list, playlist, playlist list, open channel link bar, market link, item slide, external link setting, visit statistics, following and Twitter) that suit the taste and needs of the first user can be exposed to the second user in various layouts.

In addition, since the first user is provided with a reward in exchange for sharing information about a product or a service with the second user, the first user may be motivated to find and post the latest useful information on his or her page, and the second user can easily obtain the latest useful information through the ID card.

The components illustrated in FIG. 1 may communicate through a network. Here, the network may be implemented as any type of wired/wireless communication network such as a local area network (LAN), a wide area network (WAN), a mobile radio communication network, or wireless broadband Internet (Wibro).

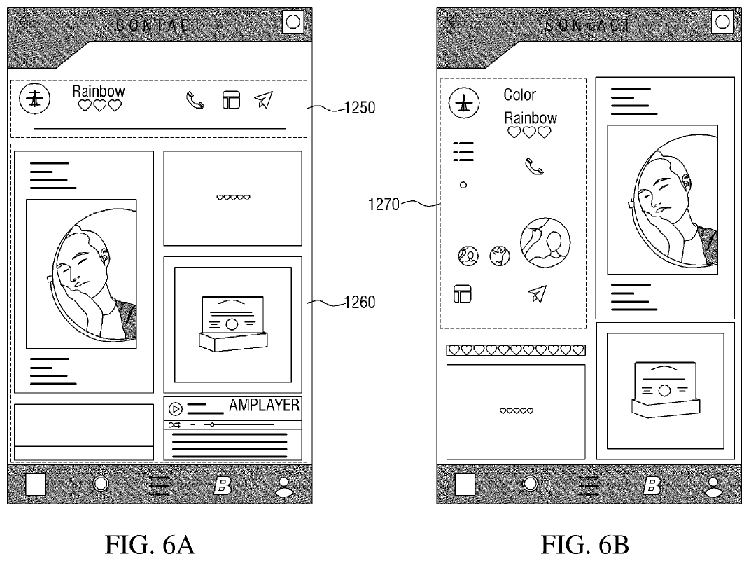

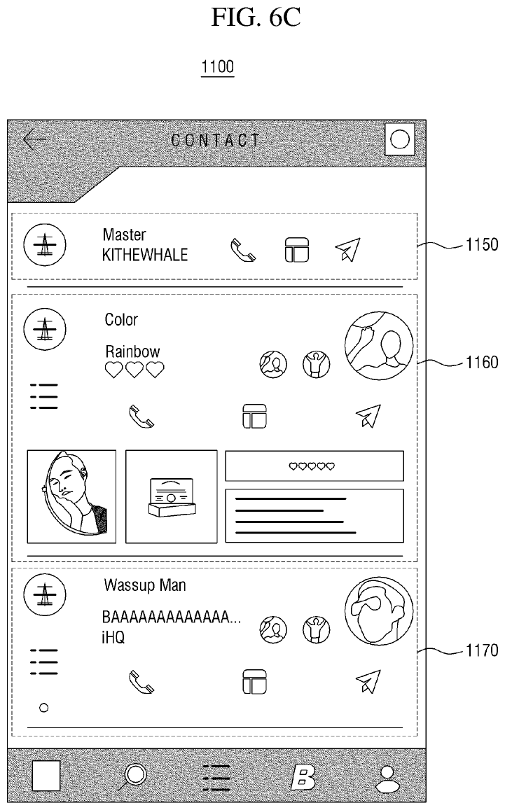

FIGS. 6A to 6C are conceptual diagrams for explaining various application embodiments in the method described in FIG. 2.

FIGS. 6A and 6B illustrate an application example of customizing an ID card to various sizes and shapes. FIG. 6C illustrates an application example of displaying ID cards of a plurality of users in different sizes.

In the embodiments of FIGS. 6A and 6B, a user may adjust his or her ID card to various sizes and shapes. For example, when the user needs a larger P-app board area 1260 to include more functional elements, the user may adjust the ID card to reduce an information area 1250 and increase the P-app board area 1260 as illustrated in FIG. 6A. Alternatively, the user may adjust the shape and position of each area. For example, as illustrated in FIG. 6B, the user may place an information area 1270 of the ID card on an upper left side and set the other area as a P-app board area.

In the embodiment of FIG. 6C, a plurality of users are allocated different profile areas according to predetermined criteria. Then, each of the users customizes elements constituting his or her profile such that his or her information is displayed within the allocated area.

For example, a first profile 1150 of a user allocated a relatively small area is customized in a concise form to include only an ID, a phone button, a message button and an e-mail button in order to provide profile information within a limited area.

On the other hand, since a second profile 1160 of a user allocated a relatively large area has a lot of space for displaying user information, it is customized to include not only an ID, a photo, a phone button, a message button and an e-mail button but also additional functional elements (e.g., P-apps) at the bottom of the second profile 1160.

Meanwhile, a third profile 1170 of a user allocated an average area displays the same level of basic user information as that illustrated in FIG. 3.

In an embodiment, the criteria based on which a plurality of users are allocated different profile areas may include a service fee that a user pays to a service provider of the current method, the number of visitors to a personal page of the user, or the number of times that a product or a service is recommended through an ID card of the user.

Although the profiles 1150, 1160 and 1170 of the users have the same width and only different heights in FIG. 6C, the present disclosure is not limited thereto. That is, the ID cards 1150, 1160 and 1170 of the users may also be allocated profile areas having different widths and heights.

According to the above embodiment, since each user competes to be allocated a larger profile area, it is easier to induce active participation of the users, which may make it easy to develop various business models.

A method of customizing an ID card according to embodiments of the present disclosure will now be described in detail with reference to FIGS. 7 through 29.

FIG. 7 is a flowchart illustrating a method of customizing a first ID card and a method by which another user queries the customized first ID card according to embodiments of the present disclosure. However, this is merely an exemplary embodiment for achieving the objectives of the present disclosure, and some operations can be added or removed as needed.

Referring to FIG. 7, an application may be installed in a first user terminal 200, and the first user terminal 200 may subscribe to a service providing the present disclosure through the application. Likewise, the application may be installed in a second user terminal 300, and the second user terminal 300 may subscribe to the service providing the present disclosure through the application.

In the embodiments of FIG. 7, the first user terminal 200 queries a server 100 for a list of functional elements to be used for customization of the first ID card. In response to the query request, the server 100 provides a list of registered functional elements and detailed information to the first user terminal 200. In an embodiment, the list of functional elements provided by the server 100 may include a list of P-apps, application programs, or applications registered with the server 100.

With reference to the provided functional element information, the first user terminal 200 performs layout customization by selecting functional elements to be posted on the first ID card and placing the selected functional elements. A custom layout generated as a result of performing the layout customization is stored in the first user terminal 200 and then registered with the server 100.

Later, when the second user terminal 300 queries the ID card of a first user, the server 100 provides the ID card reflecting the previously registered custom layout to the second user terminal 300.

Meanwhile, there may be a download request for the custom layout from the second user terminal 300. In this case, if there is consent from the first user terminal 200, the server 100 provides the requested custom layout to the second user terminal 300. Then, the server 100 provides a reward for this to the first user who created the custom layout.

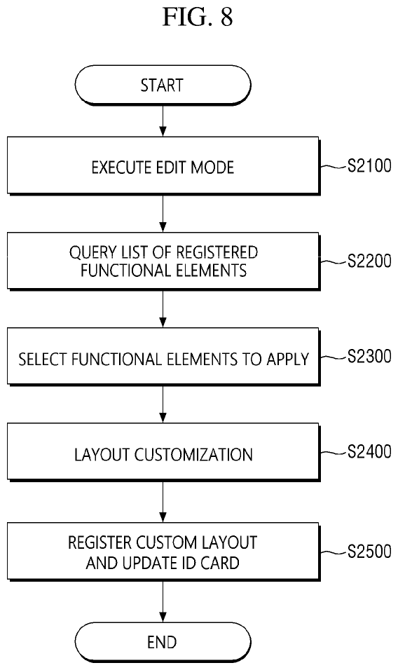

A specific method by which a user customizes his or her layout will be described with reference to FIG. 8 and subsequent drawings. Methods to be described below are mainly performed by the first user terminal 200. When the subject of an operation is not specified, it is assumed to be the first user terminal 200.

FIG. 8 is a flowchart illustrating a method of customizing a layout of an ID card according to embodiments of the present disclosure. The layout customization method of FIG. 8 includes five operations S2100 through S2500.

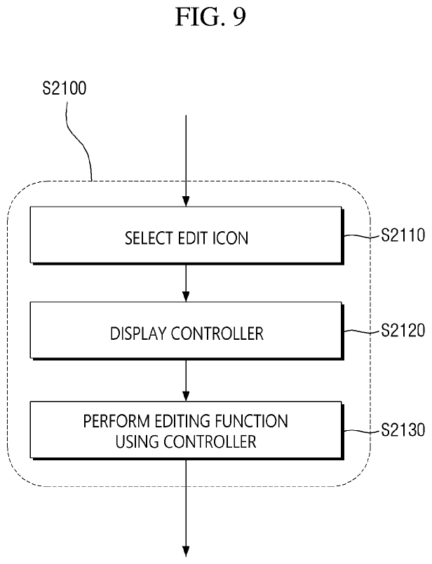

In operation S2100, a first user terminal 200 queries an ID card and executes an edit mode for editing the ID card. A specific method of executing the page edit mode will be described later with reference to FIG. 9 and subsequent drawings.

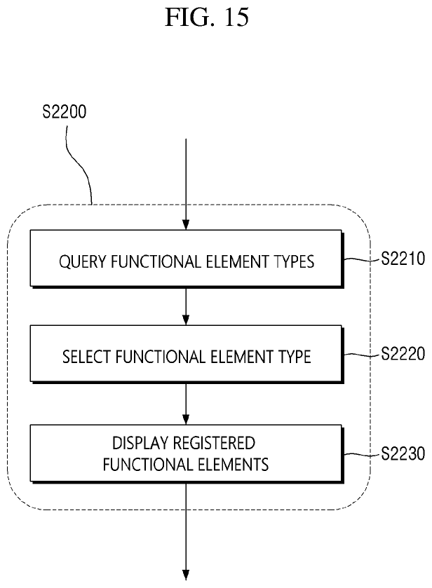

In operation S2200, the first user terminal 200 queries a list of functional elements registered with a server 100 to select functional elements to be applied to the first ID card in the edit mode. A specific method of querying a list of registered functional elements will be described later with reference to FIG. 15 and a subsequent drawing.

In operation S2300, the first user terminal 200 selects functional elements to be applied to customization with reference to the provided functional element information. In response to the selection of the first user terminal 200, the server 100 provides detailed information about the selected functional elements to the first user terminal 200. In an embodiment, the detailed information about the functional elements provided by the server 100 may include a graphic user interface (GUI) displaying each of the functional elements or an instruction for outputting a corresponding response when a user input is applied to each of the functional elements.

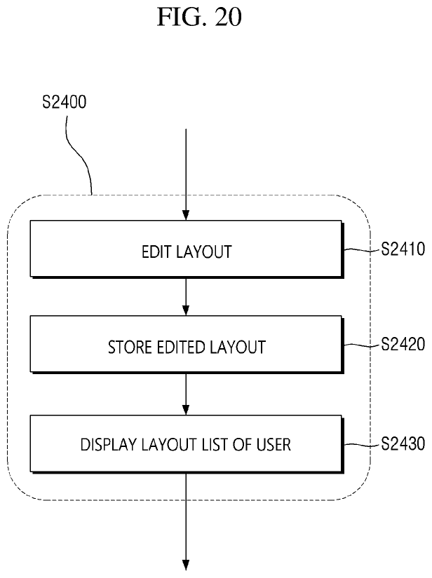

In operation S2400, the first user terminal 200 performs layout customization of the first ID card by placing the functional elements provided by the server 100 on a layout. A specific method of layout customization will be described later with reference to FIG. 20 and subsequent drawings.

In operation S2500, the first user terminal 200 stores a custom layout generated as a result of the customization and registers the custom layout with the server 100. Then, the ID card reflecting the custom layout is updated through the server 100.

According to the above embodiments of the present disclosure, the first user terminal 200 can easily customize the ID card using functional elements provided by the server 100. In addition, the first user terminal 200 can register the ID card reflecting the custom layout with the server 100.

Therefore, a first user can freely customize his or her ID card according to his or her taste and purpose and register the customization result with the server 100 so that other users can be automatically updated on the customization result. That is, the first user can update his or her ID card and a P-app board area of the ID card at any time and register the updated ID card and P-app board area with the server 100, and the registered update is stored in the server 100. Thus, when a second user queries the ID card of the first user by executing an application, the content reflecting the update is displayed to the second user. Therefore, the first user can easily deliver his or her update to the second user without having to individually contact the second user.

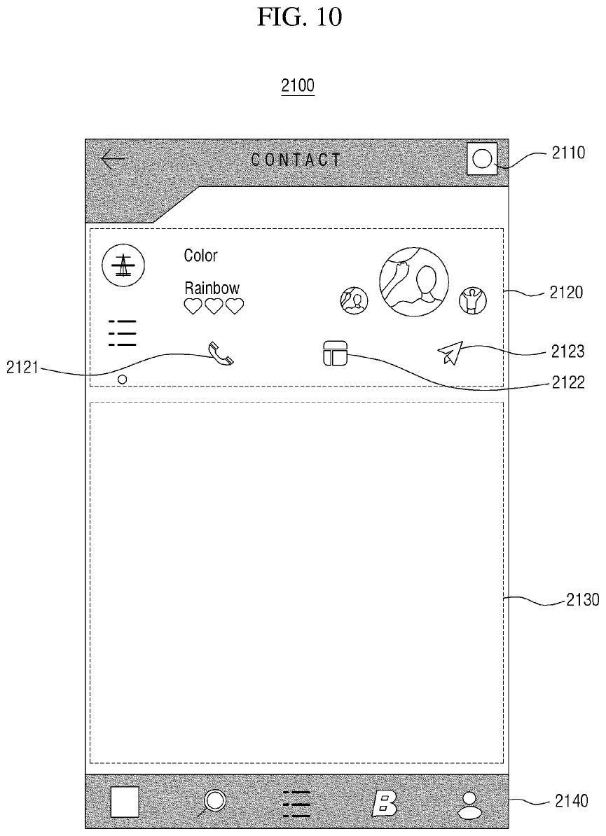

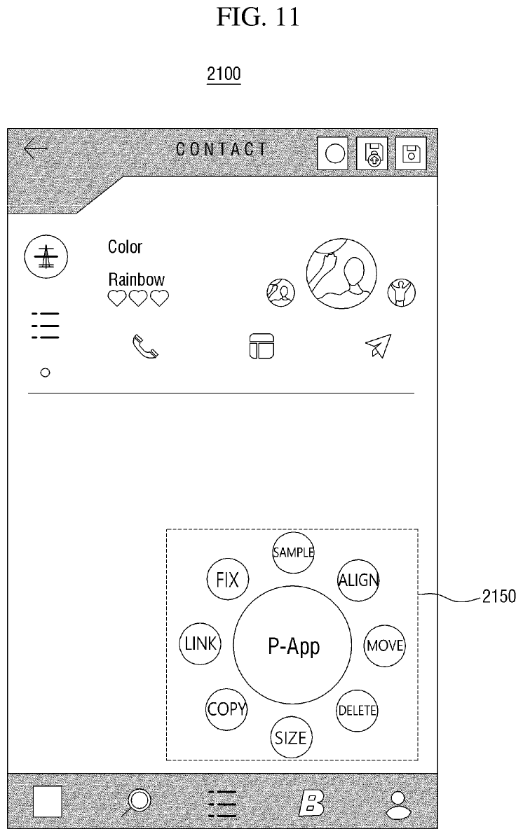

FIG. 9 is a flowchart illustrating a method of executing the page edit mode of operation S2100 of FIG. 8. In FIG. 9, a more specific embodiment of operation S2100 will be described. FIGS. 10 and 11 are conceptual diagrams for further explaining the method described in FIG. 9. FIGS. 10 and 11 respectively illustrate screens more intuitively showing operations S2110 and S2120 of FIG. 9.

In operation S2110, the first user terminal 200 selects an edit icon according to a user input. Referring to FIG. 10, an example screen of an ID card 2100 is displayed. Here, the ID card 2100 is illustrated as including an information area 2120 and a P-app board area 2130, but the present disclosure is not limited thereto.

The information area 2120 of the first ID card 2100 may include various information about a user or an ID card. For example, the information area 2120 may include the name of the ID card, additional information, affiliation information, an applied badge, a phone button, a layout list display button, an e-mail button, a timeline content view icon, and the like.

The P-app board area 2130 of the ID card 2100 is a main area to be customized according to the present disclosure, and various functional elements may be applied and placed according to the taste and purpose of the first user. A specific method of applying and placing functional elements in the P-app board area 2130 will be described later with reference to FIG. 20 and subsequent drawings.

An edit icon 2110 is placed at an upper right corner of the ID card 2100. However, the present disclosure is not limited thereto, and the edit icon 2110 can be located anywhere on the ID card 2100. When the edit icon 2110 is pressed, the first user terminal 200 executes the edit mode of the ID card 2100.

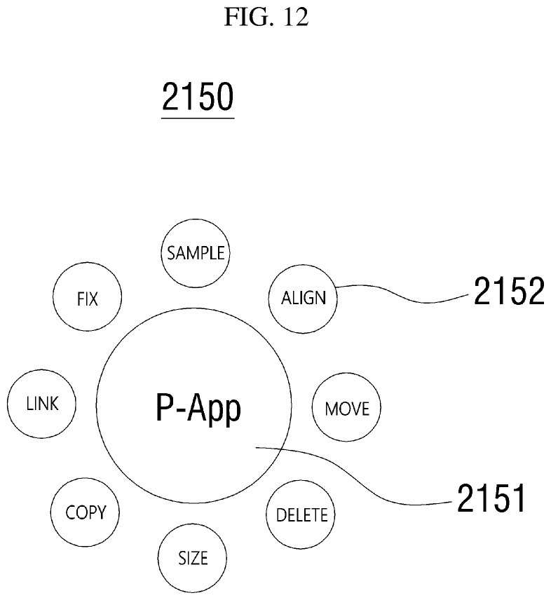

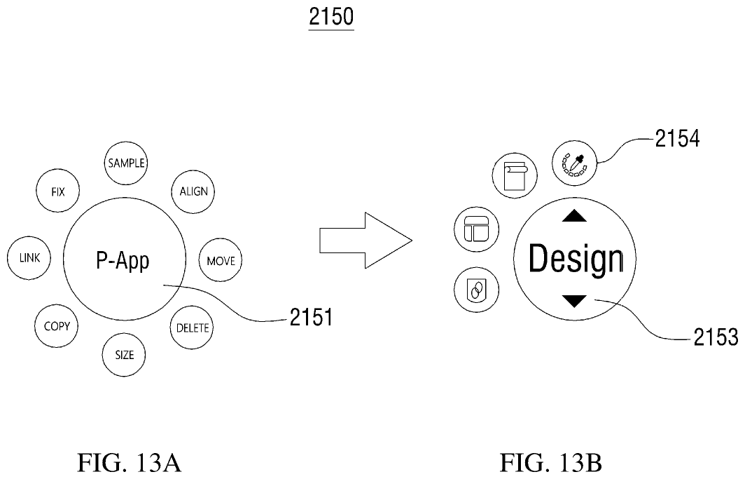

In operation S2120, the first user terminal 200 displays a controller that will facilitate editing of the ID card 2100. Referring to FIG. 11, an example form of a controller 2150 is illustrated. The controller 2150 includes various function buttons for editing the ID card 2100. The controller 2150 will be described in more detail with reference to FIGS. 12 to 13B.

FIGS. 12 to 13B are conceptual diagrams for more specifically explaining functions and a user interface (UI)/user experience (UX) of the controller 2150 described in FIG. 11. Referring to FIG. 12, the controller 2150 includes a large circle 2151 in the center and small circles 2152 around the large circle 2151. In the controller 2150, the large circle 2151 in the center is surrounded by the small circles 2152 as illustrated in FIG. 12.

The large circle 2151 indicates the type of the controller 2150. For example, the letter ‘P-App’ written in the large circle 2151 in FIG. 12 denotes that the controller 2150 is a tool for editing a P-app.

The small circles 2152 are assigned individual functions to edit the ID card 2100. For example, if ‘align’ is written in a small circle 2152, a function of aligning a P-app is executed when a user input is applied to the small circle 2152.

The large circle 2151 and the small circles 2152 may form one set. For example, as illustrated in FIG. 12, the small circles 2152 of ‘align,’ ‘move,’ ‘delete,’ ‘size,’ ‘copy,’‘connect,’ ‘fix,’ and ‘sample’ may form one P-app editing tool set together with the large circle 2151.

Although the controller 2150 is illustrated as a P-app editing tool in FIG. 12, the present disclosure is not limited thereto. For example, the controller 2150 may also be a text editing tool including functions such as ‘font change’ and ‘paragraph alignment’, an effect editing tool including functions such as ‘shadow,’ ‘blur,’ ‘rotate,’ ‘opacity’ and ‘watercolor effect,’ or a complex tool including functions such as ‘Paint,’ ‘Photoshop,’‘illustrator,’ ‘Excel’ and ‘Premiere.’

The type of the controller 2150 represented by the large circle 2151 and the individual editing functions represented by the small circles 2152 can be changed or added.

As described above, the controller 2150 is not limited to one type of function. A switch from a first type of controller to a second type of controller can be made simply by a touch input to the controller 2150.

Referring to FIGS. 13A and 13B, a method of changing the type of the controller 2150 is described. Referring to FIG. 13A, it is assumed that the current controller 2150 is a P-app editing tool. Here, when the large circle 2151 in the center is touched to change the type of the controller 2150, the type of the controller 2150 may be changed to another type. For example, the type of the controller 2150 may be changed to a design tool as in FIG. 13B. Referring to FIG. 13B, the type of the controller 2150 shown in the large circle 2153 in the center is changed to a design tool, and the small circles around the large circle 2153 are also changed to various design function buttons including a palette button 2154.

Meanwhile, the controller 2150 can be freely moved within the ID card 2100 by touches and drags.

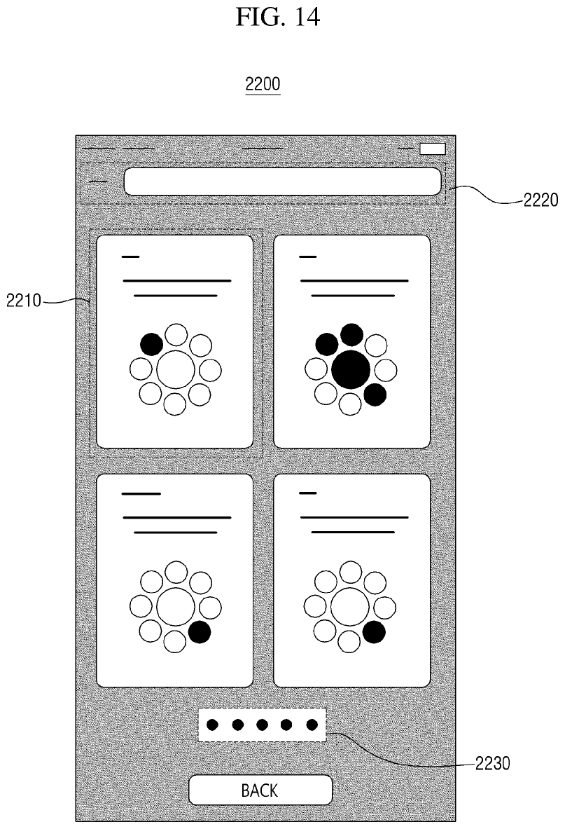

FIG. 14 is a conceptual diagram for explaining a method of registering and downloading a controller through a market according to embodiments of the present disclosure.

Referring to FIG. 14, a controller market 2200 provided by the server 100 is illustrated. When the controller market 2200 is queried through the first user terminal 200, a list of controllers registered with the server 100 is displayed. The controller market 2200 may provide a search box 2220 for searching for a registered controller and an interface 2230 for displaying a list of controllers of a next page. Various types of controllers are posted on the controller market 2200. Of the controllers, some controllers may be controllers registered by a service provider of the present disclosure, and some controllers may be controllers customized by other users. When there is a desired controller 2210 in the controller market 2200, a user may download the desired controller 2210 and add the downloaded controller 2210 to his or her controller list including the existing controller 2150, so that the user can select and use the controller 2210 when the user wants. Therefore, the user can use a controller that suits his or her preference and obtain the effect of customizing a controller UI. The above controllers may also be used by the user as editing tools to configure or edit the content of a blog P-app or create blog content and may also be freely used in various embodiments in which editing tools may be used.

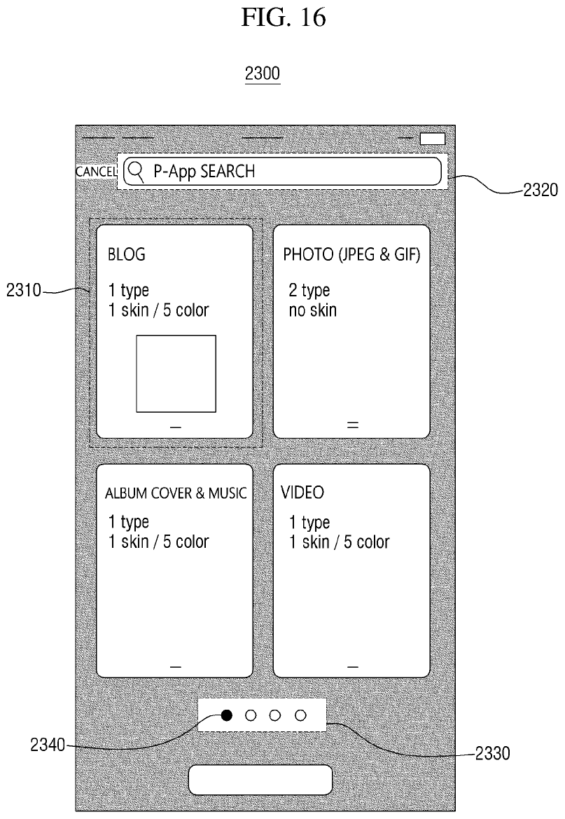

FIG. 15 is a flowchart illustrating a method of querying a list of registered functional elements in operation S2200 of FIG. 8. FIG. 16 is a conceptual diagram for further explaining the method described in FIG. 15.

Referring to FIGS. 15 and 16, in operation S2210, the first user terminal 200 queries types of registered functional elements according to a user input. An example screen 2300 for querying types of registered functional elements is illustrated in FIG. 16.

The query screen 2300 of FIG. 16 displays four types of functional elements ‘blog,’ ‘photo,’ ‘album cover & music,’ and ‘video.’ However, they are merely some of the possible types of functional elements and may also include other various types. For example, the types of functional elements may include types such as product, map, photo, GIF, video, YouTube, sound cloud, music, map, blog, guestbook, timeline view, folder link bar, folder preview box, folder slide show, folder list, playlist, playlist list, open channel link bar, market link, item slide, external link setting, visit statistics, following and Twitter

In addition, detailed information about how many subtypes are registered under each type is displayed. For example, in the case of a blog functional element type 2310, 1 type, 1 skin, and 5 color are displayed as detailed information. This means that the blog function element type 2310 has one subtype, provides one skin, and is serviced in five colors.

The query screen 2300 may provide a search box 2320 for searching for a functional element type and an interface 2330 for displaying functional element types of a next page. For example, when a black circle 2340 is located at a first position on the interface 2330, it indicates that a list of functional element types currently being displayed is a list of a first page.

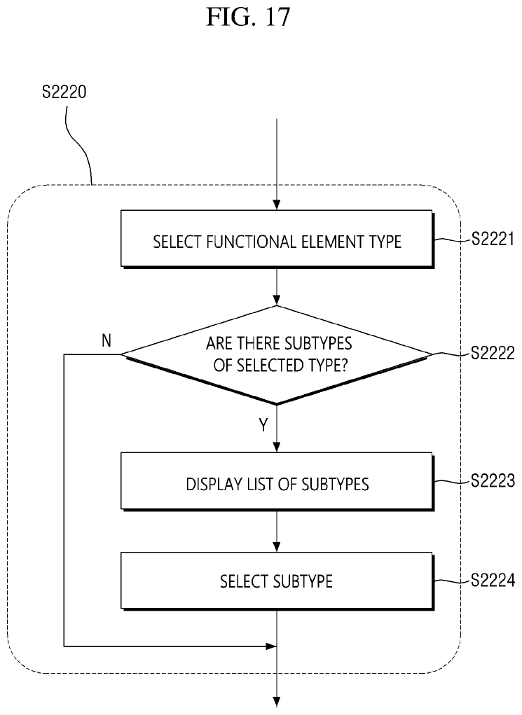

In operation S2220, the first user terminal 200 selects any one of the displayed functional element types according to a user input. A specific method by which the first user terminal 200 selects a functional element type will be described later with reference to FIG. 17 and subsequent drawings. When the first user terminal 200 selects a functional element type, information about the selected functional element type is transmitted to the server 100. In response to the information, the server 100 provides the first user terminal 200 with information about functional elements corresponding to the functional element type selected by the first user terminal 200.

In operation S2230, the first user terminal 200 displays the functional element information received from the server 100 to the first user.

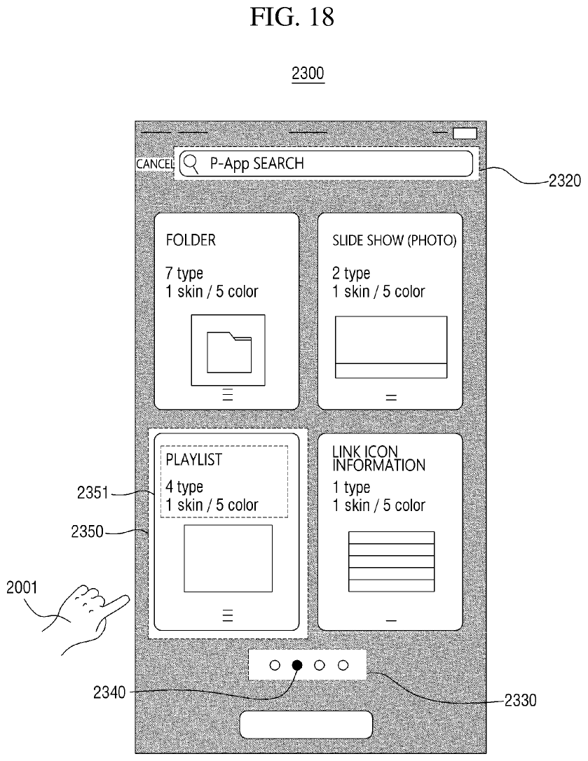

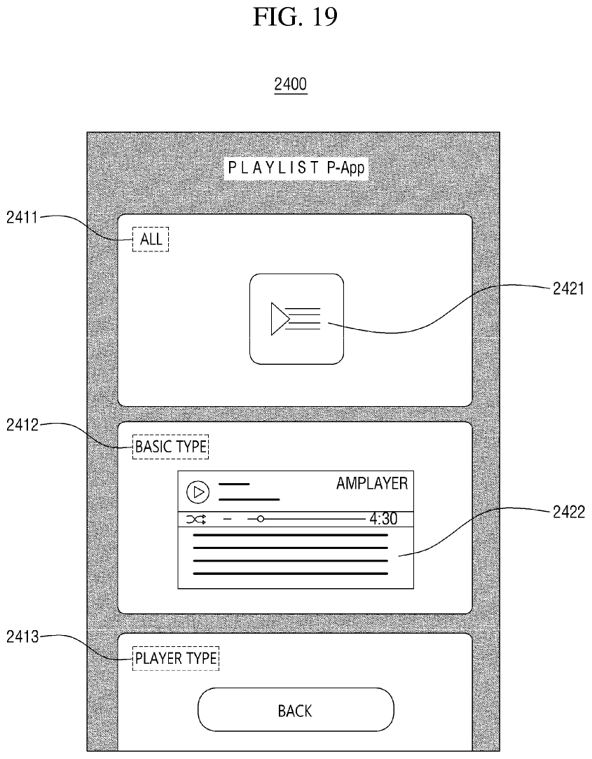

FIG. 17 is a flowchart illustrating a method of selecting a functional element type in operation S2220 of FIG. 15. FIGS. 18 and 19 are conceptual diagrams for further explaining the method described in FIG. 17.

Referring to FIGS. 17 and 18, in operation S2221, the first user terminal 200 selects any one of the functional element types on the query screen 2300.

In operation S2222, the first user terminal 200 determines whether there are subtypes of the selected functional element type. Specifically, referring to FIG. 18, a second page of the screen 2300 is illustrated. When the black circle 2340 is located at a second position on the interface 2330, it means that a list of functional element types currently being displayed is a list of the second page. It is assumed that a functional element type selected from the list of functional element types by the first user terminal 200 is a ‘playlist’ type 2350. The ‘playlist’ type 2350 has four subtypes as indicated by reference numeral 2351. In this case, since there are subtypes, the current embodiments proceed to operation S2223. On the other hand, if there are no subtypes in the ‘playlist’ type 2350, the current embodiments proceed without going through operations S2223 and S2224 of FIG. 17.

In operation S2223, the first user terminal 200 displays a list of subtypes of the selected functional element type. An example of displaying a list of subtypes is illustrated in FIG. 19. Subtypes may be displayed as names 2411, 2412 and 2413 and appearance icons 2421 and 2422 of the subtypes as illustrated in FIG. 19.

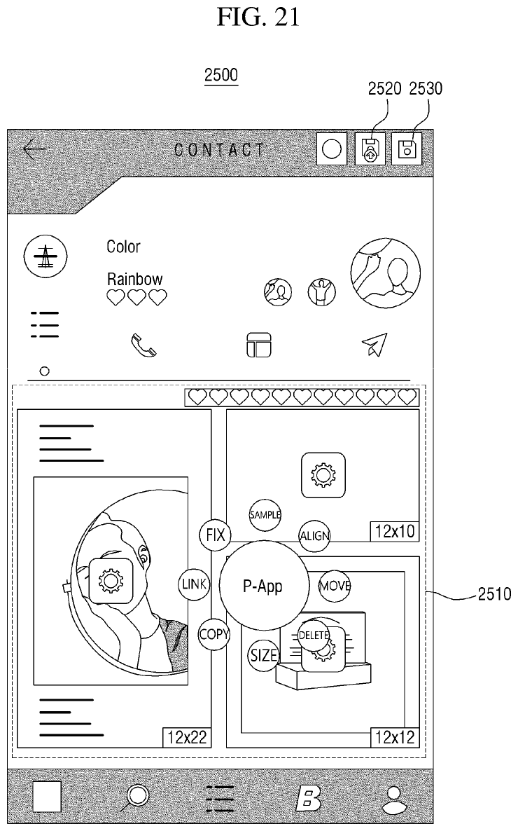

FIG. 20 is a flowchart illustrating a method of storing a customized layout in operation S2400 of FIG. 8. FIGS. 21 through 23 are conceptual diagrams for further explaining the method described in FIG. 20. FIGS. 21 through 23 respectively illustrate example screens more intuitively showing operations S2410, S2420 and S2430 of FIG. 20.

In operation S2410, the first user terminal 200 applies the functional elements selected in operation S2300 to the ID card. FIG. 21 illustrates an example screen of an ID card 2500 to which the selected functional elements have been applied. Referring to FIG. 21, it can be seen that functional elements of various sizes such as ‘12×22,’ ‘12×10,’ and ‘12×12’ have been applied to a P-app board area 2510 of the ID card 2500. The controller is shown on the ID card 2500 because the mode is still the page edit mode.

In the embodiments of the present disclosure, sizes of placed functional elements (e.g., P-apps) may be freely adjusted by a user. For example, a functional element placed at a size of ‘12×22’ may be freely adjusted to a size of ‘12×12’ or ‘6×32’ by the user. In addition, the position of a functional element in the P-app board area 2510 may be freely adjusted. For example, a functional element located on a left side of the P-app board area 2510 may be swapped placed with a functional element located on a right side. Alternatively, other functional elements may be deleted, and only one functional element may be placed at the center of the P-app board area 2510.

An upload button 2520 and a save button 2530 are displayed at the top of the ID card 2500. The upload button 2520 is a button for registering a layout (hereinafter, referred to as a ‘custom layout’) of the customized ID card 2500 of FIG. 21 with the server 100. Through the upload button 2520, the user may register his or her custom layout on a layout list. The save button 2530 is a button for storing the custom layout of FIG. 21 in the terminal 200 of the user and the server 100.

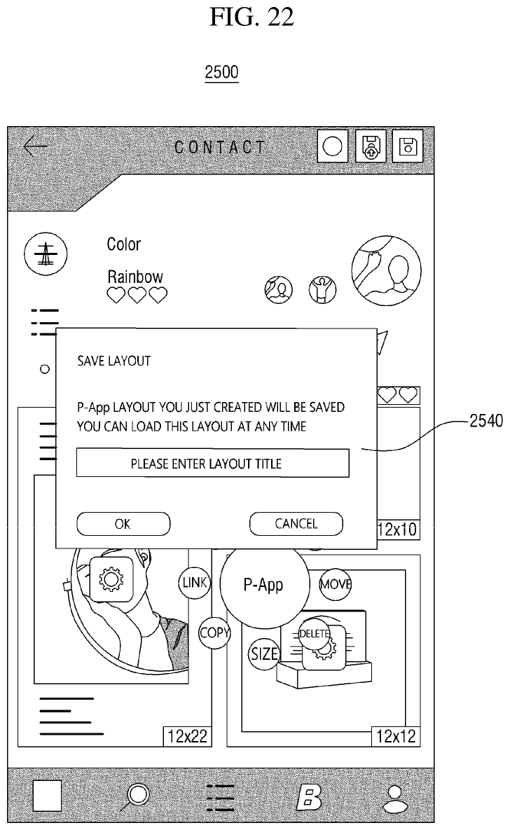

In operation S2420, the first user terminal 200 stores the edited custom layout in the layout list according to a user input. Operation S2420 may be omitted when the user does not want to store his or her custom layout. The storing of the custom layout may be performed by applying a user input to the upload button 2520 of the ID card 2500 as described in FIG. 21. Here, the custom layout may also be stored in the server 100. When a save input is made, a Save Layout window is displayed, and the title of the layout is entered. An example screen displayed when the upload button 2520 is touched is illustrated in FIG. 22. A Save Layout window 2540 is displayed over the ID card 2500, and a field for entering the title of the layout is provided. Here, when an OK button is pressed after the title is entered, the storing of the custom layout is completed.

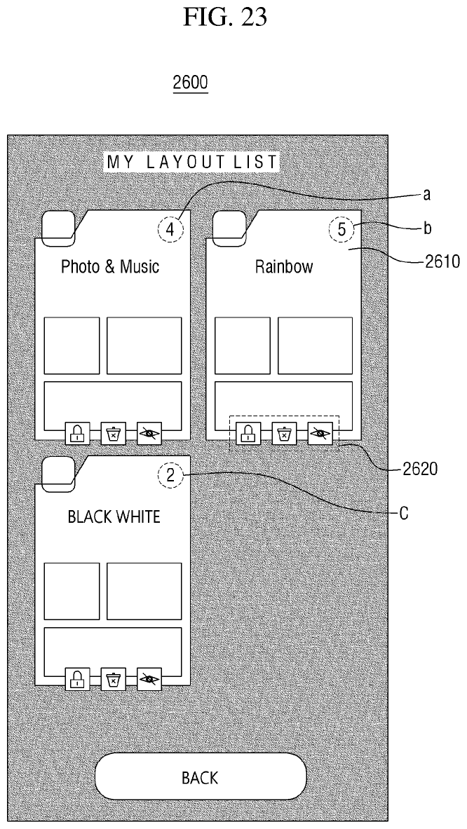

In operation S2430, the first user terminal 200 displays a stored layout list 2600 of the user. Here, the displayed layout list 2600 may include a basic layout provided by the server 100, the custom layout edited by the first user terminal 200, a layout clipped from a custom layout of another person, and/or a layout purchased from a layout market. On the layout list 2600, a representative image and name 2610 of each stored layout may be displayed, and an editing interface 2620 for the layout list may be displayed. In an embodiment, a Lock Layout button, a Delete Layout button, or a Publish Layout button may be further displayed on the layout list 2600. Furthermore, when layout lists of other people are to be queried, a Clip Layout button may be further displayed on the layout list 2600. In addition, a number indicating the number of times each layout has been shared with other people or clipped by other people may be further displayed (see a, b and c of FIG. 23).

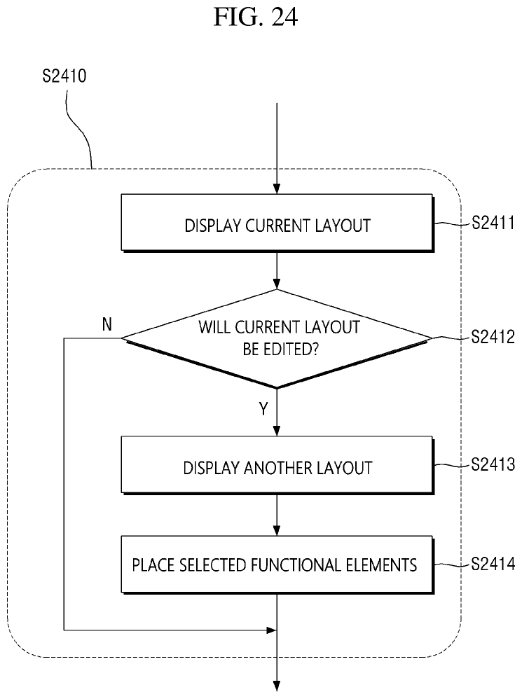

FIG. 24 is a flowchart illustrating a specific embodiment of operation S2410 of FIG. 20. In the embodiment of FIG. 24, a method of editing a current layout, loading and editing an existing layout, or generating a new ID card to create a new layout will be described.

First, in operation S2411, the current layout of the ID card 2500 is displayed.

In operation S2412, it is determined whether to edit the current layout or another layout (e.g., an existing stored layout or a layout of a new ID card). If it is determined to edit the current layout, the method according to the current embodiment proceeds to operation S2414 without going through operation S2413. If it is determined to load and edit a layout, the method according to the current embodiment proceeds to operation S2413.

In operation S2413, the first user terminal 200 loads and displays an existing layout stored in the ID card 2500 or generates a new ID card and displays its empty layout according to a user input.

In operation S2414, the first user terminal 200 places selected functional elements on the displayed layout according to a user input.

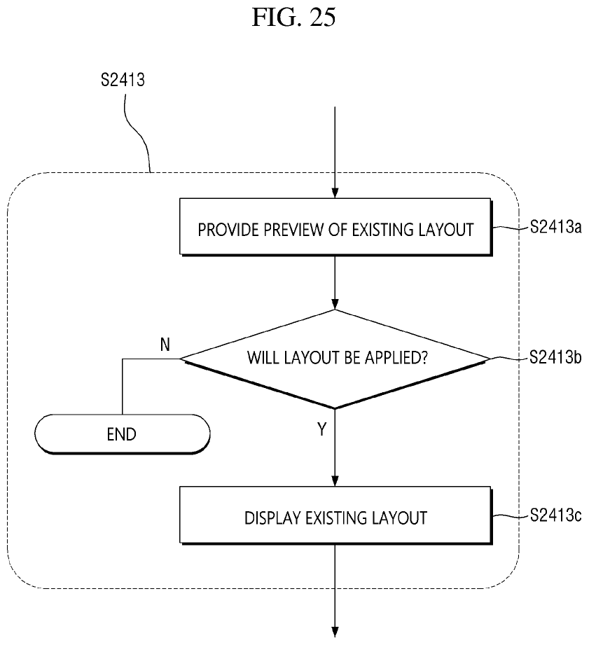

FIG. 25 is a flowchart illustrating a method of displaying another layout in operation S2413 of FIG. 24. In the embodiment of FIG. 25, a case of selecting and loading one of stored layouts includes providing a preview of the loaded layout and determining whether to apply the layout.

In operation S2413a, the first user terminal 200 provides a preview of a loaded layout displayed on the ID card 2500.

In operation S2413b, the first user terminal 200 determines whether to apply the previewed layout according to a user input. If the layout is not to be applied, the method according to the current embodiment is terminated. If the layout is to be applied, the method according to the current embodiment proceeds to operation S2413c.

In operation S2413c, the first user terminal 200 displays the loaded layout on the ID card 2500.

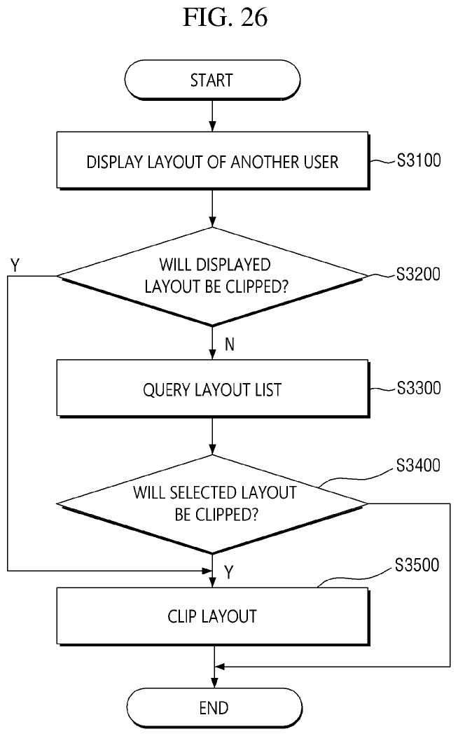

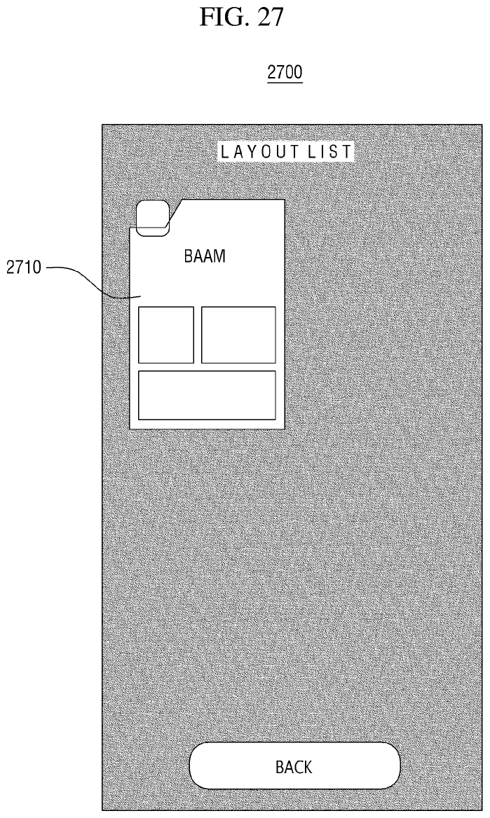

FIG. 26 is a flowchart illustrating a method of clipping and storing a layout of another user according to embodiments of the present disclosure. FIGS. 27 through 29 are conceptual diagrams for further explaining the method described in FIG. 26. FIGS. 27 through 29 respectively illustrate example screens more intuitively showing operations S3100, S3200 and S3400 of FIG. 26.

Referring to FIGS. 26 through 29, in operation S3100, the first user terminal 200 queries an ID card of another user.

In operation S3200, the first user terminal 200 determines whether to clip a currently displayed layout according to an input of the first user. If it is determined to clip the current layout, the current embodiments proceed directly to operation S3500 to perform an instruction to clip the layout. If not, the current embodiments proceed to operation S3300.

In operation S3300, the first user terminal 200 queries a layout list of another user according to an input of the first user.

In operation S3400, the first user terminal 200 selects a specific layout from the queried layout list and determines whether to clip the selected layout according to an input of the first user. If it is determined to clip the selected layout, the current embodiments proceed to operation S3500 to perform the instruction to clip the layout. If not, the current embodiments are terminated.

Referring to FIG. 27, a screen 2700 displaying a layout list of another user is illustrated. The first user terminal 200 may select a layout 2710 to be clipped from the displayed list.

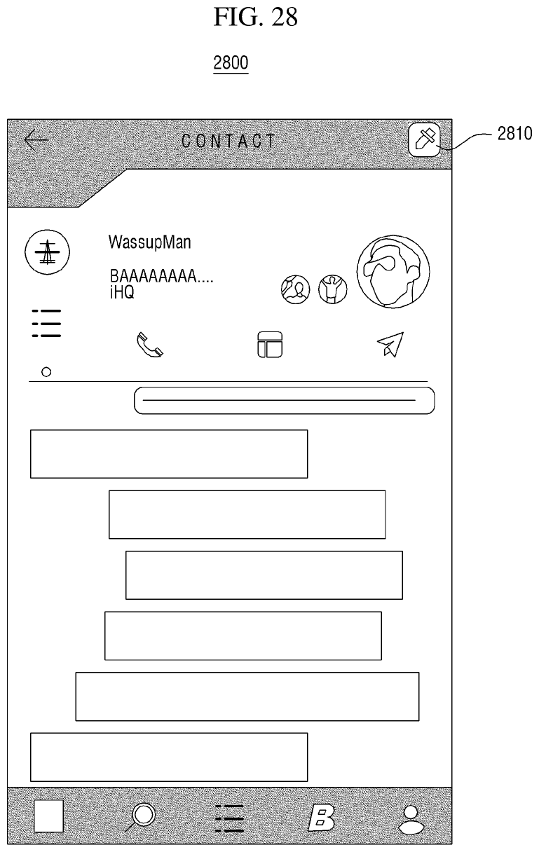

In an embodiment, the first user terminal 200 may provide a preview of a layout to be clipped. Referring to FIG. 28, an example screen 2800 displaying a preview of a selected layout is illustrated. An eyedropper button 2810 is provided at an upper right corner of the screen 2800. The eyedropper button 2810 is a button for executing an instruction to clip the layout.

When the instruction to clip the layout is executed after the provided preview is viewed, the first user terminal 200 clips the layout and stores the clipped layout in a layout list space allocated to the first user of the first user terminal 200 or the server 100. The stored layout is included in the layout list of the first user.

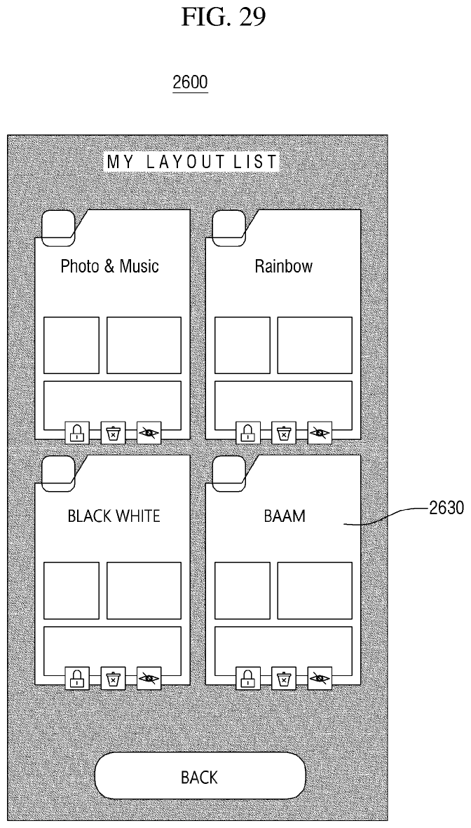

FIG. 29 illustrates a layout list screen 2600 including a clipped layout. It can be seen that a clipped layout 2630 has been added to the layout list of FIG. 23.

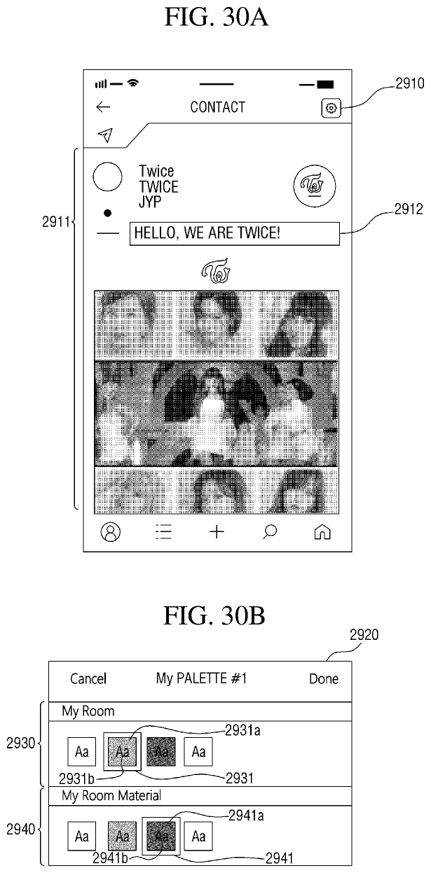

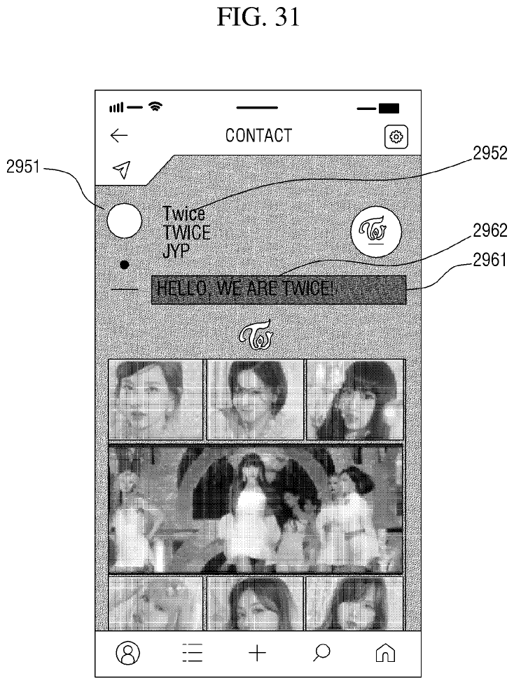

FIGS. 30A to 31 are conceptual diagrams for explaining a method of customizing a color scheme of an ID card according to embodiments of the present disclosure. FIGS. 30A and 30B illustrate a specific method by which a user changes colors of an ID card, and FIG. 31 illustrates a final output obtained by customizing the colors using the method.

A user's ID card whose colors are to be customized is illustrated in FIG. 30A. In the color customization method described in the current embodiments, a method of independently customizing colors of a master style 2911 and an individual component style 2912 that constitute the ID card will be described. However, this is merely an example, and the scope of the present disclosure is not limited thereto. For example, if there is a third style in the ID card, in addition to the master style 2911 and the component style 2912, a color of the third style may also be customized in the same way. Here, the master style 2911 is a style representing the overall image of a My Room screen and includes the overall background, font, color tone, etc. of My Room. The component style 2912 is a style representing an image of an individual component of the My Room screen and includes the background, font, color tone, etc. of a specific component (e.g., a notice bar or a badge).

The user may call a palette menu 2920 for color customization by selecting a setting button 2910 of the ID card. In FIG. 30B, an example form of the palette menu 2920 is illustrated.

In an embodiment, when the user selects the setting button 2910, the controller 2150 described in FIGS. 11 through 13B is displayed on the ID card. When the user selects a ‘palette’ function in a menu of the controller 2150, the palette menu 2920 is finally displayed. In this way, the palette menu 2920 may be called.

The palette menu 2920 may include a first menu 2930 for editing the color of the master style 2911 and a second menu 2940 for editing the color of the component style 2912. If there is a third style, the palette menu 2920 may further include a third menu for editing the color of the third style.

Each of the first menu 2930 and the second menu 2940 may include one or more palette colors. Referring to FIGS. 30A and 30B, each of the first menu 2930 and the second menu 2940 includes four palette colors. However, this is merely an example, and the number of palette colors included in each of the menus 2930 and 2940 is not limited. For example, the first menu 2930 may include ten palette colors, and the second menu 2940 may include only one palette color.

In an embodiment, each palette color may include a plurality of partial colors. Here, the partial colors may represent colors of different elements included in a style to which a palette color is applied.

Specifically, referring to FIG. 30B, it is assumed that a first palette color 2931 is selected in the first menu 2930. As illustrated in the drawing, the first palette color 2931 includes a first partial color 2931a represented by a background color and a second partial color 2931b represented by a font color. Here, the first partial color 2931a and the second partial color 2931b may represent colors of different elements among the elements constituting the master style 2911. For example, the first partial color 2931a may represent the color of the background, buttons or status bar of the master style 2911, and the second partial color 2931b may represent the color of letters, icons or numbers among the elements constituting the master style 2911.

When the user applies the first palette color 2931 to the master style 2911 by using the palette menu 2920, the color of each element of the master style 2911 is changed to a corresponding partial color of the first palette color 2931. In the above example, the color of the background, the buttons or the status bar among the elements constituting the master style 2911 is changed to the first partial color 2931a, and the color of the letters, the icons or the numbers among the elements constituting the master style 2911 is changed to the second partial color 2931b.

If color customization is performed using a palette color composed of a plurality of partial colors as described above, different colors can be given to individual elements of a style simply by applying one palette color. This increases the variety of color expression and negates the need to manually assign, one by one, palette colors to individual elements of a style, thus enabling very easy and fast color customization. Although a case where a palette color includes two partial colors is described here as an example, the number of partial colors included in the palette color is not limited. For example, the palette color may further include a third partial color. In this case, the third partial color may be represented by a border color of the palette color, or a part of the background in the palette color may be allocated to the third partial color so as to distinguish the third partial color from other partial colors.

Likewise, a palette color of the second menu 2940 may also include a plurality of partial colors. In this case, the partial colors may represent colors of different elements of the component style 2912. Other details of the second menu 2940 and its palette color are substantially the same as those of the first menu 2930 and its palette color described above. Thus, further description is omitted in order to avoid redundancy.

FIG. 31 illustrates an ID card whose colors have been customized by the method described in FIGS. 30A and 30B. It is assumed that each of the first palette color 2931 and a second palette color 2941 has been selected in the palette menu 2920 of FIGS. 30A and 30B and applied to the ID card of FIG. 31.

Referring to FIG. 31, it can be seen that the application of the first palette color 2931 to the master style 2911 has changed a background color 2951 of the master style 2911 to the first partial color 2931a of the first palette color 2931 and a font color 2952 of the master style 2911 to the second partial color 2931b of the first palette color 2931.

Similarly, it can be seen that the application of the second palette color 2941 to the component style 2912 has changed a background color 2961 and a font color 2962 of the component style 2912 to partial colors 2941a and 2941b of the second palette color 2941, respectively.

Hereinafter, an exemplary computing device 500 that can implement an apparatus and a system, according to various embodiments of the present disclosure will be described.

FIG. 32 is an example hardware diagram illustrating a computing device 500.

As shown in FIG. 32, the computing device 500 may include one or more processors 510, a memory 530 which loads a computer program 591 executed by the processors 510, a bus 550, a communication interface 570, and a storage 590 for storing the computer program 591. However, FIG. 32 illustrates only the components related to the embodiment of the present disclosure. Therefore, it will be appreciated by those skilled in the art that the present disclosure may further include other general purpose components in addition to the components shown in FIG. 32.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. An example of the memory 530 may be a volatile memory such as a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present disclosure are implemented. When the computer program 591 is loaded on the memory 530, the processor 510 may perform the methods/operations in accordance with various embodiments of the present disclosure by executing the one or more instructions.

The technical features of the present disclosure described with reference to FIG. 1 through FIG. 32. so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A method of providing a customized identification (ID) card, the method being performed by a computing device and comprising:
displaying a profile of a user; and
displaying an ID card of the user in response to selecting the profile of the user,
wherein the ID card comprises one or more functional elements, and a layout of the ID card is customized according to an input of the user.

2. The method of claim 1, wherein the user is a first user, and further comprising:
receiving an input of a second user for at least one of the functional elements included in the ID card; and
providing a response to the received input.

3. The method of claim 2, further comprising providing the first user with a reward for the provision of the response.

4. The method of claim 1, wherein the displaying of the profile comprises displaying a profile of another user together with the profile of the user.

5. The method of claim 1, wherein the ID card comprises a board area in which the functional elements are located, and the board area can be adjusted in size and shape by the user.

6. The method of claim 1, wherein the functional elements can be adjusted in size and position in the ID card by the user.

7. The method of claim 1, wherein the layout of the ID card is a layout customized by querying a list of functional elements provided by a server, selecting functional elements to be applied to the layout from the queried functional element list; and placing the selected functional elements on the layout.

8. The method of claim 1, wherein the functional elements are P-apps, application programs, or applications.

9. A method of providing a customized ID card, the method being performed by a computing device and comprising:
querying a list of functional elements provided by a server;
selecting functional elements to be applied to the ID card from the queried functional element list; and
customizing a layout of the ID card by placing or setting the selected functional elements on the layout,
wherein the ID card is provided in response to selecting a profile associated with the ID card.

10. The method of claim 9, further comprising registering the customized layout with the server.

11. The method of claim 10, wherein the customized layout registered with the server is provided to another user through the server in response to a request of the another user.

12. The method of claim 9, further comprising executing an edit mode of the ID card to customize the layout.

13. The method of claim 12, wherein the executing of the edit mode comprises displaying a controller which provides an editing tool for the ID card, and the controller comprises a first circle in a center and a plurality of second circles surrounding the first circle.

14. The method of claim 13, wherein the first circle represents a type of the editing tool provided by the controller, and each of the second circles represents an editing function of the editing tool.

15. The method of claim 9, wherein the type of the editing tool represented by the first circle or the editing function represented by each of the second circles can be changed or added.

16. The method of claim 9, wherein the layout is a layout clipped from a layout of another user.

17. The method of claim 9, further comprising editing a color of a style constituting the ID card, wherein the style comprises a master style or a component style of the ID card.

18. The method of claim 17, wherein the editing of the color comprises selecting a palette color to be applied to the style, and the palette color comprises a first partial color and a second partial color distinguished from the first partial color, wherein any one of the first partial color and the second partial color represents a color of a first element of the style, and the other partial color represents a color of a second element of the style.

19. The method of claim 18, wherein the first element comprises a background, buttons or a status bar of the style, and the second element comprises letters, icons or numbers of the style.

20. An apparatus for providing a customized ID card, the apparatus comprising:
a processor,
a memory which loads a computer program to be executed by the processor; and
a storage which stores the computer program,
wherein the computer program comprises instructions for performing an operation of displaying a profile of a user and an operation of displaying an ID card of the user in response to selecting the profile of the user, wherein the ID card comprises one or more functional elements, and a layout of the ID card is customized according to an input of the user.
